(19) United States
(12) Patent Application Publication
(10) Pub. No.: US 2014/0026850 A1
(43) Pub. Date: Jan. 30, 2014

(54) SUPPLY SYSTEM FOR SUPPLYING AN INTERNAL COMBUSTION ENGINE WITH AIR AND FUEL

(71) Applicant: I.C.P. S.r.l., Castelnuovo Don Bosco (IT)

(72) Inventor: Tancredi Razzano, Piova'Massaia (IT)

(73) Assignee: I.C.P. S.r.l., Castelnuovo Don Bosco (IT)

(21) Appl. No.: 13/737,751

(22) Filed: Jan. 9, 2013

(30) Foreign Application Priority Data
Jan. 9, 2012 (IT) TO2012A 000005

(51) Int. Cl. F02D 41/30

(52) U.S. Cl. CPC F02D 41/30
USPC 123/337

(57) ABSTRACT

A supply system, fur supplying an internal combustion engine with air and fuel, is provided with a first fuel supply circuit, having at least one electro-injector controlled b an electronic unit, an intake conduit conveying combustion air, a throttle valve in the intake conduit, and a second fuel supply circuit, activated in the event of failure and having a nozzle that atomizes fuel due to a depression in the intake conduit; a fuel flow rate adjusting valve varies the flow rate exiting from the nozzle, under the operation of a mechanical transmission; according to the operation of the throttle valve.

### CROSS REFERENCE TO RELATED APPLICATIONS

This application claims priority under 35 U.S.C. §119 to Italian Patent Application No. TO2012A 000005, filed Jan. 9, 2012, the entirety of which is hereby incorporated by reference,

### FIELD OF THE INVENTION

The present invention relates to a supply system for supplying an internal combustion engine with air and fuel.

### BACKGROUND OF THE INVENTION

As known, in internal combustion engines of the injection type, the fuel is injected into the cylinders (direct injection), or in a combustion air intake conduit (indirect injection), by way of injectors having electromagnets, or other types of electric, actuators, which are controlled by an electronic unit as a function of the how rate of intake combustion air to set the injection timing. In particular, the electronic unit communicates with other engine devices and receives signals from measuring sensors (lambda sensor, mass flow sensor, throttle valve position sensor, temperature and pressure sensors, etc. . . . ) related to the engine operating parameters.

Due to the precision in the determination of the amount or fuel and the pressure of the fuel injected (which causes a fine pulverization of the fuel itself), it is possible to obtain high performance and low fuel consumption and to limit the emissions of pollutants.

When the electronic injection engines are applied on airplanes, in particular on ultralight aircraft, the need is felt to provide devices that allow the engine to operate properly even in the event of a failure of the injection system and/or a failure that causes an interruption in the electric supply to the injectors and fuel pumps.

### SUMMARY OF THE INVENTION

The purpose of the present invention is to provide a supply system for supplying an internal combustion engine with air and fuel, which allows satisfaction of the need set forth above in a simple and economic way.

According to the present invention, a supply system is provided for supplying an internal combustion engine with air and fuel. In one embodiment, the invention can be a supply system for supplying an internal combustion engine with air and fuel, the system comprising: a first fuel supply circuit, comprising at least one electro-injector controlled, in use, by electrical signals emitted by an electronic unit so as to inject pressurized fuel; an intake conduit for conveying combustion air to said engine; a throttle valve operable for varying the combustion air flow rate in said intake conduit; a second fuel supply circuit, comprising a nozzle configured to atomize fuel into said intake conduit due to a depression in said intake conduit; a flow rate adjusting valve for varying the fuel flow rate exiting from said nozzle; a mechanical transmission which mechanically operates said flow rate adjusting valve according to the operation of said throttle valve; and switching means that selectively activate either one or the other of said first and second fuel supply circuit; characterized in that said switching means comprise control means configured so as to activate said second fuel supply circuit in case of failure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF DRAWINGS

The invention will now be described with reference to the accompanying drawings, which show a non-limiting embodiment, wherein:

FIG. 1 is a block diagram of a preferred embodiment of the supply system for supplying an internal combustion engine with in and fuel, according to the present invention;

FIG. 2 shows, in cross section, a detail of the system of FIG. 1;

FIG. 3 is a bottom view of the detail of FIG. 2; and

FIG. 4 is similar to FIG. 2 and shows, on an enlarged scale, a variant of a detail of FIG. 2.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are Inc convenience of description only and do not require that the apparatus be constructed or operated in a particular orientation unless explicitly indicated as such. Terms such as “attached,” “affixed,” “connected” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

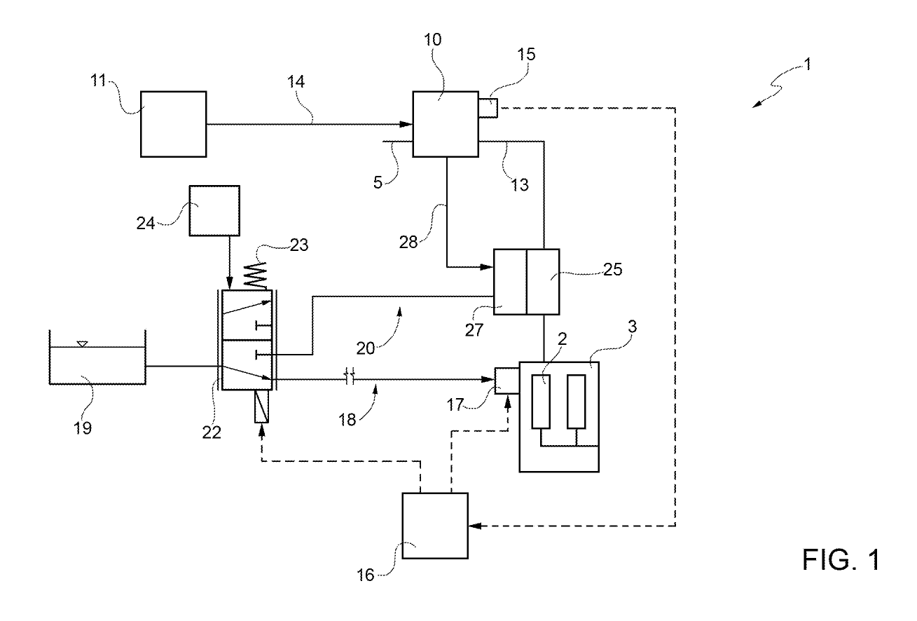

In FIG. 1, a supply system 1 for supplying air and fuel into the cylinders 2 of an internal combustion engine 3 is schematically illustrated

The system 1 comprises an intake conduit 5, which conveys combustion air from an external environment to the intake valves of the cylinders 2 and a throttle valve 10, for example a butterfly valve, of a type known per se, which is connected by way of a mechanical transmission 14 to a control member 11 (shown schematically), for example an accelerator pedal, which is operable by a user. The throttle valve 10, when operated, varies the flow passage in a portion 13 of the intake conduit 5 and, therefore, regulates the combustion air flow rate towards the engine 3. In the case of a butterfly valve, the portion 13 is normally referred to as “throttle housing.” Preferably, the transmission 14 is of the type with Bowden cable. As an alternative to the mechanical transmission, an electric operation, also commonly called “fly by wire” can be provided.

The position of the movable element of the throttle valve 10 is detected by a position sensor 15, which emits a signal indicative of the restriction of the passage section. Said signal is received by an electronic unit 16, which determines, in a known way and not described in detail, the flow rate of combustion air conveyed to the engine 3 and controls one or more electro-injectors 17 by way of electrical signals to adjust the dosage of fuel entering the cylinders 2. In the case of direct injection, each cylinder 2 is provided with a respective electro-injector 17. In the case of indirect injection, a single electro-injector 17 can be provided which injects fuel into the intake conduit 5.

The electro-injector 17 constitutes part of a supply circuit 16, which conveys fuel from a tank 19. In parallel to the circuit 18, the system 1 comprises a supply circuit 20, which is independent from the circuit 18, and is adapted to convey fuel in the intake conduit 5 due to a depression into the intake conduit 5.

In normal operating conditions, the system 1 operates according to a first configuration wherein the circuit 18 of the “injection” type is active, for which the air/fuel mixture necessary for supplying the engine 3 is adjusted by way of the electronic unit 16. In this configuration, the nozzle 25 is isolated and does not receive fuel, for example because the circuit 20 is inhibited by a selector valve 22, which diverts the fuel from the tank 19 to the circuit 18.

The system 1 can operate in a second configuration, wherein the circuit 20 is active, while the circuit 18 is isolated and does not receive fuel. To switch to the second configuration, the valve 22 is switched so as to divert the fuel from the tank 19 to the circuit 20 and isolate the circuit 18.

Alternatively to the valve 22, other technical devices may be provided having the same function, for example appropriate shut-off valves adapted to change configuration of the system 1 and selectively activate one or the other of the circuits 20, 18.

According to a preferred aspect of the invention, the circuit 20 is activated automatically in the event of an interruption of power supply. In fact, in the example schematically illustrated, the valve 22 is a two-position monostable electro-valve, controlled by the control unit 16. In the absence of electrical signal from the control unit 16 (for example a power failure), the valve 22 is automatically switched as a result of its own elastic element 23, so as to supply fuel to the circuit 20.

Alternatively or in combination with the automatic mechanical switching, the circuit 20 can be forcibly manually activated by a user by way of a control member 24, which is mechanically connected to the valve 22, in order to directly intervene in case of failure.

Furthermore, in combination or as an alternative to the above, to switch the system 1 in the second configuration a real-time control by the control unit 16 can be provided, which comprises a diagnosis function of the system 1 and, in case of failure of the circuit 18, controls the closing of the circuit 18 and the opening of the circuit 20.

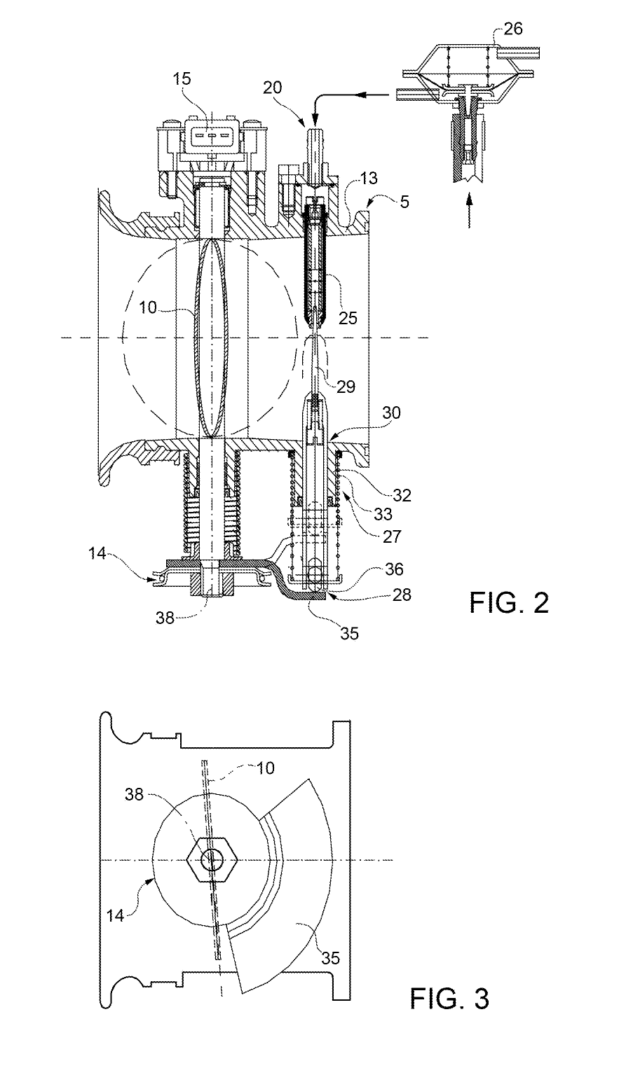

With reference to FIG. 2, the circuit 20 ends with as nozzle 25, which is arranged in the intake conduit 5 and has a function of atomizer, as it is provided with holes such as to atomize the flowing out fuel because of the depression in the intake conduit 5. The vacuum is generated by the fact that the portion 13 has to diffuser or Venturi shape and, preferably, the nozzle 25 is arranged in the portion 13 downstream of the throttle valve 10. In the preferred embodiment shown in FIG. 2, the circuit 20 also comprises a pressure regulator 26 which is arranged between the valve 22 and the nozzle 25 and operates according to the pressure in the intake conduit 5.

The fuel flow exiting from the circuit 20 is adjusted by the movable element of a valve 27. This movable element is operated by a mechanical transmission 28 in response to mechanical operation of the movable element of the throttle valve 10. In particular, the transmission 28 connects the throttle valve 10 to the movable element of the valve 27 and is arranged outside the intake conduit 5. Alternatively, the transmission 28 connects the control member 11 to the movable element of the valve 27 and acts together and in parallel to the transmission 14.

In particular, the movable element oldie valve 27 is of the sliding type. Conveniently, said movable element is defined by a needle 29, which is coaxial to the nozzle 25, is arranged in a position diametrically opposed to the nozzle 25 with respect to the axis of the intake conduit 5 and is connected in fluid tight manner to the portion 14 by way of a guide and slide coupling 30.

In particular, the portion 14 comprises an outer projection 32, which performs the guiding function on the needle 29. According to the preferred embodiment shown, the transmission 28 comprises an elastic element 33 which tends to open the nozzle 25 by exerting a thrust on the needle 29 outwards and is defined, in particular, by a helical spring fitted around the portion 32.

The transmission 28 comprises, moreover, a cam 35 operated by the movable element of the throttle valve 10, and a tappet 36, which is pressed against the cam 35 and moves together with the needle 29. In particular, the cam 35 rotates together with the butterfly element of the throttle valve 10 about an axis 38 parallel to the translation axis of the needle 29, and is defined by a ramp which extends in the form of an arc of a circle around the axis 38 (FIG. 3). The tappet 36 is maintained by the elastic, element 33 against the ramp: FIG. 2 shows the two end positions assumed by the tappet 36 due to the rotation of the ramp 35.

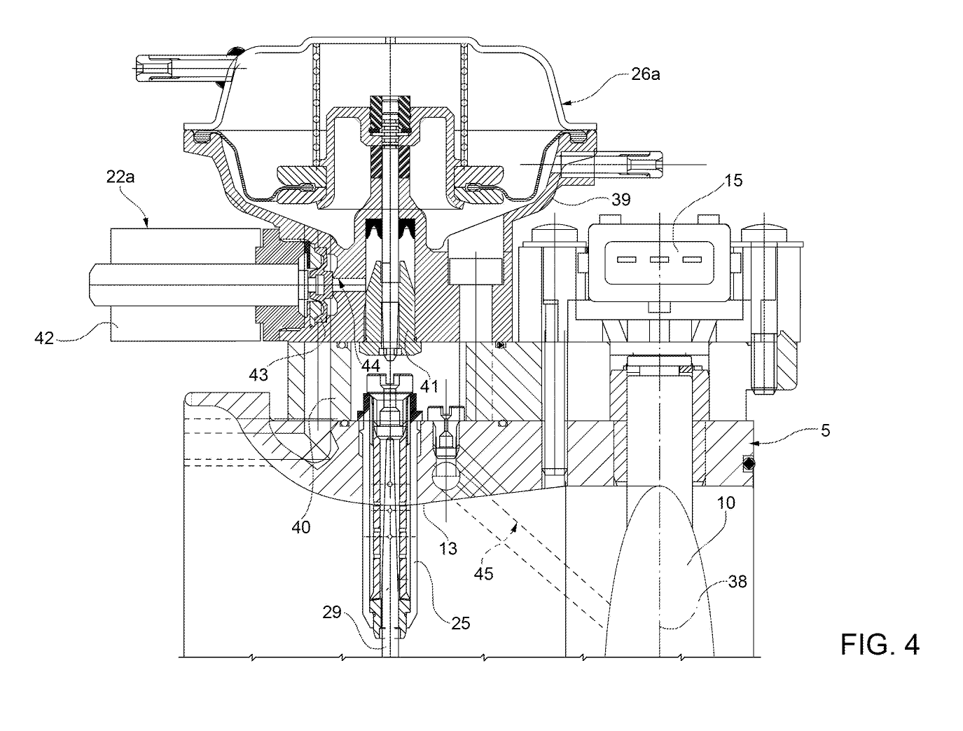

FIG. 4 shows some variants that may be provided in combination or alternatively to one another:
the valve 27 is arranged upstream of the throttle valve 10;
the pressure regulator 26 is replaced by a pressure regulator 26a, which comprises a body 39 fixed to the portion 13, in particular by way of a connecting, element 40, and a shutter 41 coaxial to the nozzle 25; the shutter 41 operates as a function of the pressure difference between upstream and downstream of the throttle valve 10;
the valve 22 is replaced by a valve 22a, which is also fixed to the portion 13; in particular, the valve 22a is integrated in the pressure regulator 26, as it comprises an electro-actuator 42 fixed to the body 39; the electro-actuator 42 operates a shutter 43 so as to open/close the fuel passage by way of a valve seat 44 obtained in the body 39;
the circuit 20 comprises a system 45 (partially shown) for the so-called “minimum” supply.

The advantage of system 1 is to use under normal conditions an “injection” supply system that ensures optimum performance with respect to efficiency, fuel consumption, emissions, etc . . . , but to be able to exploit a supply system similar to that of a carburetor when the “injection” supply system suffers failure.

The combination of the two systems provides a redundancy that ensures the safety in case of application of the system 1 on an airplane, in the event of failures, without having a simple duplication of an “injection” supply system or a simple duplication of a carburetor supply system.

The characteristics of the system 1 allows to limit constructive complications and consequently the costs of the system 1 itself, and are designed to switch the configuration to the circuit 20 in case of necessity in a simple and/or automatic way.

In particular, even in the complete absence of power supply, the engine 3 continues to regularly operate, without causing inconvenience to the flight on the aircraft upon which it is installed.

Other advantages of the features described, above are then obvious for a person skilled in the art, in particular with regard to the compactness and simplicity of construction

From the above it is, finally, clear that the system 1 described can be subject m modifications and variants which do not depart from the scope of protection of the present invention, as defined in the appended claims.

In particular, in the circuit 20, the pressure regulator 26 may be absent, and/or a fuel tank with floats can be provided.

Moreover, the valves 10 and or 27 may be different from those described and/or the transmission 28 could be different from that indicated by way of example, as a function of available spaces and/or as a function of the type of valves 10 and 27.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A supply system for supplying an internal combustion engine with air and fuel, the system comprising;
a first fuel supply circuit, comprising at least one electro-injector controlled, in use, by electrical signals emitted by an electronic unit so as to inject pressurized fuel;
an intake conduit for conveying combustion air to said engine;
a throttle valve operable for varying the combustion air flow rate in said intake conduit;
a second fuel supply circuit, comprising a nozzle configured to atomize fuel into said intake conduit due to a depression in said intake conduit;
a flow rate adjusting valve for varying the fuel flow rate exiting from said nozzle;
a mechanical transmission which mechanically operates said flow rate adjusting valve according to the operation of said throttle valve;
switching means that selectively activate either one or the other of said first and second fuel supply circuit; and
wherein said switching means comprise control means configured so as to activate said second fuel supply circuit in case of failure.

2. The system according to claim 1, wherein said control means are configured so as to activate said second fuel supply circuit automatically and by way of mechanical elements in the absence of electrical power.

3. The system according to claim 2, wherein said switching means comprise at least one solenoid valve provided with an elastic element which activates said second fuel supply circuit automatically in the absence of electrical control signals.

4. The system according to claim 1, wherein said control means comprises a manually operable control element for activating said second fuel supply circuit.

5. The system according to claim 1, wherein said control means comprise an electronic unit configured so as to perform a system diagnosis and control the activation of said second fuel supply circuit in case of failure.

6. The system according to claim 1, wherein said switching means comprise at least one solenoid valve fixed to said intake conduit.

7. The system according to claim 6, wherein said solenoid valve is integral with a pressure regulator fixed to said intake conduit.

8. The system according to claim 1, wherein said mechanical transmission connects said throttle valve to said flow rate adjusting valve.

9. The system according to claim 8, wherein said throttle valve is defined by a butterfly valve, and said mechanical transmission comprises:
a cam set in rotation by said butterfly valve; and
a tappet, which rests against said cam and operates a sliding shutter of said flow rate adjusting valve.

10. The system according to claim 1, wherein said flow rate adjusting valve comprises a needle, which is coaxial to said nozzle and is placed in a diametrically opposite position to said nozzle with respect to the axis of said intake conduit.
